(19) United States
(12) Patent Application Publication
(10) Pub. No.: US 2020/0349604 A1
(43) Pub. Date: Nov. 5, 2020

(54) PACING FOR BALANCED DELIVERY

(71) Applicant: Microsoft Technology Licensing, LLC, Redmond, WA (US)

(72) Inventors: Sahin C. Geyik, Redwood City, CA (US); Xi Chen, San Jose, CA (US); Yu Wang, Sunnyvale, CA (US); Keqing Liang, Sunnyvale, CA (US); Wen Pu, Santa Clara, CA (US)

(73) Assignee: Microsoft Technology Licensing, LLC, Redmond, WA (US)

(21) Appl. No.: 16/401,822

(22) Filed: May 2, 2019

(51) Int. Cl. G06Q 30/02; G06Q 10/10

(52) U.S. Cl. CPC G06Q 30/0244; G06Q 30/0277; G06Q 30/0273; G06Q 10/1053

(57) ABSTRACT

The disclosed embodiments provide a system that performs pacing for balanced delivery. During operation, the system obtains predicted response rates associated with impressions of a content item delivered within an online system and a cost per action (CPA) for the content item. Next, the system determines an impression-based spending for the content item based on the predicted response rates and the CPA. The system then calculates a pacing score for the content item based on the impression-based spending. Finally, the system adjusts subsequent interactions with the content item based on the pacing score.

### RELATED APPLICATIONS

The subject matter of this application is related to the subject matter in a co-pending non-provisional application entitled “Dynamic Optimization for Jobs,” having Ser. No. 16/232,862, and filing date 26 Dec. 2018 (Attorney Docket No. LI-902407-US-NP).

The subject matter of this application is also related to the subject matter in a co-pending non-provisional application filed on the same day as the instant application, entitled “Calibration of Response Rates,” having serial number TO BE ASSIGNED, and filing date TO BE ASSIGNED (Attorney Docket No. LI-902484-US-NP).

### BACKGROUND

### Field

The disclosed embodiments relate to delivery of content in online systems. More specifically, the disclosed embodiments relate to impression-based pacing for balanced delivery of content in online systems.

### Related Art

Online networks may include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as online networks that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals may use an online network to locate prospects, maintain a professional image, establish and maintain relationships, and/or engage with other individuals and organizations. Similarly, recruiters may use the online network to search for candidates for job opportunities and/or open positions. At the same time, job seekers may use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for delivering content in an online system in accordance with the disclosed embodiments.

FIG. 3 shows a flowchart illustrating a process of performing impression-based pacing of delivery of a content item in accordance with the disclosed embodiments.

FIG. 4 shows a flowchart illustrating a process of performing post-ranking calibration of a response rate to a content item in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for delivering content in online systems. For example, the content may include jobs and/or other opportunities that are posted within an online system such as an online network and/or online marketplace. Each job is associated with a daily and/or other time-based budget that is spent as candidates view, click on, apply to, and/or perform other actions related to the job. As a result, bid prices for each job may be dynamically adjusted so that the job's budget can be consumed over the course of the day instead of running out too early and/or failing to be used up by the end of the day. Bid prices for jobs may also, or instead, be dynamically adjusted to improve application rates, applicant quality, revenue and/or other performance factors related to the jobs.

More specifically, the disclosed embodiments provide a method, apparatus, and system for performing impression-based pacing for balanced delivery of content. Impression-based spending for a content item (e.g., job, advertisement, etc.) is calculated based on predicted response rates to the content item (e.g., predicted click-through rates (CTRs), predicted conversion rates, predicted application rates, etc.) and a cost per action (e.g., cost per click (CPC), cost per job application, cost per conversion, etc.) for the content item. For example, predicted CTRs for a set of impressions of a job may be multiplied with the CPC for the job to produce expected costs of the impressions, and the expected costs of the impressions may be summed into the impression-based spending for the job.

The impression-based spending is used to calculate a pacing score that controls delivery of the content item based on the utilization of the content item's budget. For example, a current value of the pacing score at a given time may be calculated based on the previous value of the pacing score, a desired spending for the content item at the time, and the impression-based spending. The pacing score is then used to determine the position of the content item in a ranking of content items, and the ranking is outputted to members of the online system and/or otherwise used to adjust subsequent interactions between the members and the content item. For example, a higher value of the pacing score may result in a higher position and/or increased prominence of the content item in the ranking, while a lower value of the pacing score may result in a lower position and/or reduced prominence of the content item in the ranking.

By estimating spending based on impressions of content, the disclosed embodiments are able to assess the utilization of budgets for the content on a more granular and/or frequent basis. In turn, the budget utilizations can be used to control the subsequent delivery of content in a way that prevents overspending or underspending related to the content.

In contrast, conventional techniques may determine spending and/or budget utilization for content based on more infrequent and/or erratic actions such as clicks and/or conversions, as well as prices charged per click and/or conversion, which can be a significant proportion of the budgets for the content. As a result, conventional spending and/or budget utilization estimates may fail to capture up-to-date exposure of users to the content, even when the exposure is sufficient and/or frequent enough to lead to actions that spend the budgets for the content. Instead, pacing and/or delivery of content based on the conventional spending and/or budget utilization estimates may result in overthrottling or underthrottling of the delivery of the content, which can cause suboptimal spending or lack of spending of the corresponding budgets. Consequently, the disclosed embodiments may provide improvements in computer systems, applications, user experiences, tools, and/or technologies related to delivering online content and/or carrying out activities within online systems.

### Pacing for Balanced Delivery

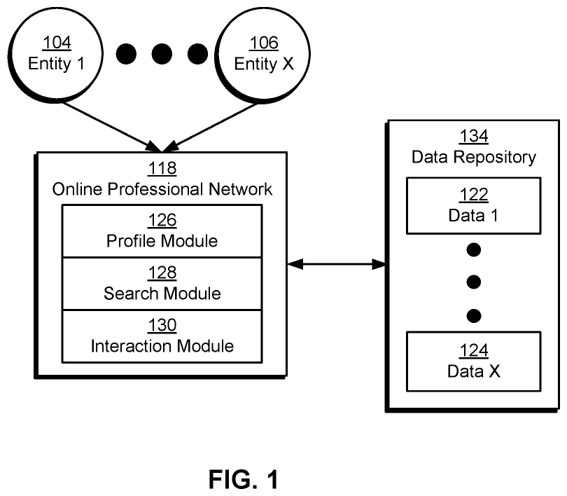

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that delivers, to the entities, the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

In one or more embodiments, data repository 134 stores data that represents standardized, organized, and/or classified attributes for the users or entities. For example, skills in data repository 134 may be organized into a hierarchical taxonomy. The taxonomy may model relationships between skills and/or sets of related skills (e.g., “Java programming” is related to or a subset of “software engineering”) and/or standardize identical or highly related skills (e.g., “Java programming,” “Java development,” “Android development,” and “Java programming language” are standardized to “Java”).

In another example, locations in data repository 134 may include cities, metropolitan areas, states, countries, continents, and/or other standardized geographical regions. Like standardized skills, the locations may be organized into a hierarchical taxonomy (e.g., cities are organized under states, which are organized under countries, which are organized under continents, etc.).

In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve other data that is represented by the time periods (e.g., starting a job in a given month or year, graduating from university within a five-year span, job listings posted within a two-week period, etc.).

In some embodiments, standardized attributes in data repository 134 are represented by unique identifiers (IDs) in the corresponding taxonomies. For example, each standardized skill may be represented by a numeric skill ID in data repository 134, each standardized title may be represented by a numeric title ID in data repository 134, each standardized location may be represented by a numeric location ID in data repository 134, and/or each standardized company name (e.g., for companies that exceed a certain size and/or level of exposure in the online system) may be represented by a numeric company ID in data repository 134.

In one or more embodiments, data in data repository 134 is used to generate recommendations and/or other insights related to listings of jobs or opportunities within online network 118. For example, one or more components of online network 118 may track searches, clicks, views, text input, applications, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend a number of job listings to current or potential job seekers in online network 118.

More specifically, data in data repository 134 and one or more machine learning models are used to produce rankings related to candidates for jobs or opportunities listed within or outside online network 118. The candidates may include users who have viewed, searched for, or applied to jobs, positions, roles, and/or opportunities, within or outside online network 118. The candidates may also, or instead, include users and/or members of online network 118 with skills, work experience, and/or other attributes or qualifications that match the corresponding jobs, positions, roles, and/or opportunities.

After the candidates are identified, profile and/or activity data of the candidates may be inputted into the machine learning model(s), along with features and/or characteristics of the corresponding opportunities (e.g., required or desired skills, education, experience, industry, title, etc.). The machine learning model(s) may output scores representing the strengths of the candidates with respect to the opportunities and/or qualifications related to the opportunities (e.g., skills, current position, previous positions, overall qualifications, etc.). For example, the machine learning model(s) may generate scores based on similarities between the candidates' profile data with online network 118 and descriptions of the opportunities. The model(s) may further adjust the scores based on social and/or other validation of the candidates' profile data (e.g., endorsements of skills, recommendations, accomplishments, awards, etc.).

In turn, rankings based on the scores and/or associated insights may improve the quality of the candidates and/or recommendations of opportunities to the candidates, increase user activity with online network 118, and/or guide the decisions of the candidates and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may output a ranking of candidates for a given set of job qualifications as search results to a recruiter after the recruiter performs a search with the job qualifications included as parameters of the search. In a fourth example, the component(s) may output a ranking of jobs as search results to a candidate after the candidate specifies one or more attributes of the jobs in a job search. In a fifth example, the component(s) may recommend jobs to a candidate based on the predicted relevance or attractiveness of the jobs to the candidate and/or the candidate's likelihood of applying to the jobs.

Jobs, advertisements, and/or other types of content displayed or delivered within online network 118 may also be associated with time-based limitations or constraints. For example, posters of jobs may pay per click, application, and/or other action taken with respect to the jobs by members of online network 118. The posters may set daily budgets for the jobs, from which costs are deducted as the members take the corresponding actions with the jobs. If a job's budget is fully consumed before the end of the day, the job may continue to be delivered to members (e.g., in search results and/or recommendations) until the end of the day without further charging the job's poster. Moreover, jobs with depleted budgets may occupy space in rankings that are shown to the members, which may prevent online network 118 from surfacing other jobs to the members and/or utilizing the budgets for the other jobs.

In one or more embodiments, online network 118 manages daily budgets and/or other constraints or priorities associated with jobs and/or other content in online network 118 by performing dynamic optimization of bid prices for the jobs. For example, online network 118 may calculate a new cost per click (CPC) for each job every time the job is outputted in search results and/or a ranking to one or more candidates. The CPC may be calculated to reflect anticipated interactions with the job, improve utilization of the job's budgets, increase the jobs' performance with respect to applications or applicants, and/or accommodate other optimization objectives. As a result, the bid prices may allow for a more even exposure of members to the jobs and/or may better reflect the “values” of the jobs within online network 118 and/or recent interactions or feedback related to the jobs. Dynamic optimization of job bids is described in further detail in a co-pending non-provisional application entitled “Dynamic Optimization for Jobs,” having Ser. No. 16/232,862 and filing date 26 Dec. 2018 (Attorney Docket No. LI-902407-US-NP), which is incorporated herein by reference.

In one or more embodiments, online network 118 further includes functionality to perform impression-based pacing of jobs and/or other content to balance delivery of the content to members of online network 118. For example, online network 118 may estimate a current spending for a job based on predicted click-through rates (CTRs) associated with impressions of the job over a time period over which the job's budget is spent and CPCs for the job. Online network 118 may calculate a pacing score based on the current spending and an expected spending for the job at the current time. Online network 118 may then adjust the position of the job in a ranking that is outputted to one or more members and/or otherwise modulate delivery of the job to the member(s) based on the pacing score.

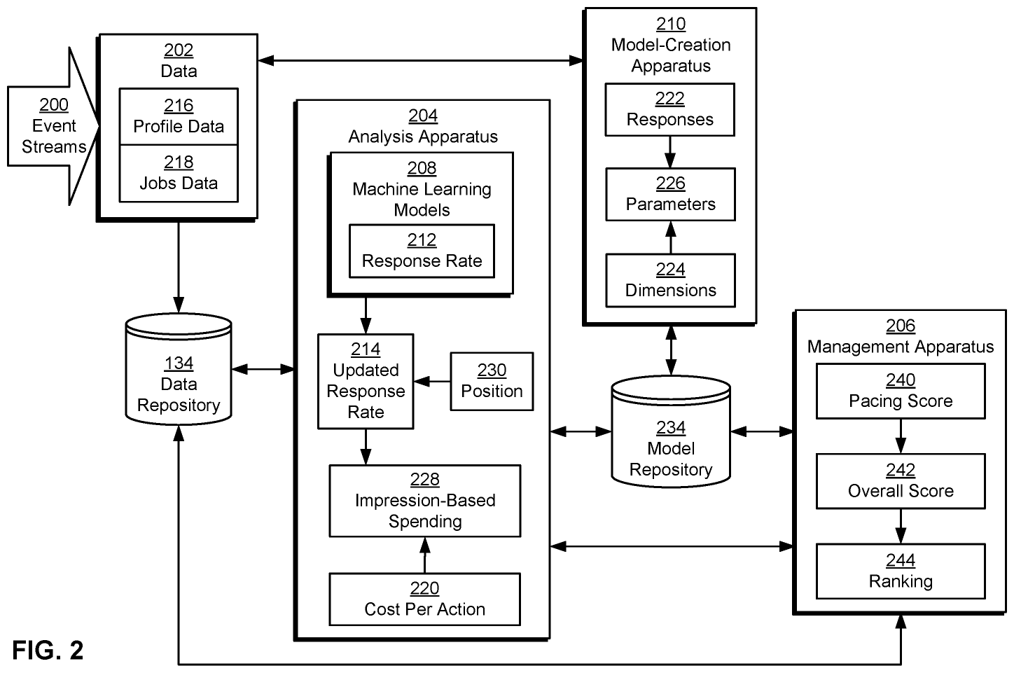

As shown in FIG. 2, data repository 134 and/or another primary data store may be queried for data 202 that includes profile data 216 for members of an online system (e.g., online network 118 of FIG. 1), as well as jobs data 218 for jobs that are listed or described within or outside the online system.

Profile data 216 includes data associated with member profiles in the online system. For example, profile data 216 for an online professional network may include a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 may also include a set of groups to which the user belongs, the user's contacts and/or connections, and/or other data related to the user's interaction with the online system.

Attributes of the members from profile data 216 may be matched to a number of member segments, with each member segment containing a group of members that share one or more common attributes. For example, member segments in the online system may be defined to include members with the same industry, title, location, and/or language.

Connection information in profile data 216 may additionally be combined into a graph, with nodes in the graph representing entities (e.g., users, schools, companies, locations, etc.) in the online system. Edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

Jobs data 218 includes structured and/or unstructured data for job listings and/or job descriptions that are posted and/or provided by members of the online system and/or external entities. For example, jobs data 218 for a given job or job listing may include a declared or inferred title, company, required or desired skills, responsibilities, qualifications, role, location, industry, seniority, salary range, benefits, and/or member segment.

Data 202 in data repository 134 may further be updated using records of recent activity received over one or more event streams 200. For example, event streams 200 may be generated and/or maintained using a distributed streaming platform such as Apache Kafka (Kafka™ is a registered trademark of the Apache Software Foundation). One or more event streams 200 may also, or instead, be provided by a change data capture (CDC) pipeline that propagates changes to data 202 from a source of truth for data 202. For example, an event containing a record of a recent profile update, job search, job view, job click, job application, response to a job application, connection invitation, post, like, comment, share, and/or other recent member activity within or outside the community may be generated in response to the activity. The record may then be propagated to components subscribing to event streams 200 on a nearline basis.

Analysis apparatus 204 uses one or more machine learning models 208 to obtain an estimated response rate 212 for a given impression of a job (or another content item). In one or more embodiments, response rate 212 represents a likelihood of a certain type of response to the impression, such as a click, like, save, and/or job application. For example, machine learning models 208 may include a logistic regression model that generates a score between 0 and 1 representing the predicted CTR by a candidate for a job, given an impression of the job by the candidate. The score may also, or instead, represent the likelihood of another positive outcome between the candidate and job (e.g., the candidate applying to the job, the candidate receiving a response to the job application, adding the candidate to a hiring pipeline for the job, interviewing the candidate for the job, hiring the candidate for the job, etc.), given an impression of the job by the candidate.

In one or more embodiments, machine learning models 208 include a global version, a set of personalized versions, and a set of job-specific versions. The global version may include a single machine learning model that tracks the behavior or preferences of all candidates with respect to all jobs in data repository 134. Each personalized version of the model may be customized to the individual behavior or preferences of a corresponding candidate with respect to certain job features (e.g., a candidate's personal preference for jobs that match the candidate's skills). Each job-specific version may identify the relevance or attraction of a corresponding job to certain candidate features (e.g., a job's likelihood of attracting candidates that prefer skill matches).

The output of the global version, a personalized version for a given candidate, and/or a job-specific version for a given job may be combined to generate a score representing the predicted probability of the candidate applying to the job, clicking on the job, and/or otherwise responding positively to an impression or recommendation of the job. For example, scores generated by the global version, personalized version, and job-specific version may be aggregated into a sum and/or weighted sum that is used as the candidate's predicted probability of responding positively to the job after viewing the job.

Features inputted into global, personalized, and/or job-specific versions of machine learning models 208 may include, but are not limited to, the candidate's title, skills, education, seniority, industry, location, and/or other professional and/or demographic attributes. The features may also include job features such as the job's title, industry, seniority, desired skill and experience, salary range, and/or location.

The features may further include candidate-job features such as cross products, cosine similarities, statistics, and/or other combinations, aggregations, scaling, and/or transformations of the candidate's and/or job's attributes. For example, the features may include cosine similarities between standardized versions of all of the candidate's skills and all of the job's skills. The candidate-job features may also, or instead, include measures of similarity and/or compatibility between one attribute of the candidate and another attribute of the job (e.g., a match percentage between a candidate's “Java” skill and a job's “C++” skill) and/or an overall “match” or “relevance” score between the candidate and the job (e.g., as outputted by a different machine learning model).

After features for a candidate-job pair are inputted into global, personalized, and/or job-specific versions of one or more machine learning models 208, analysis apparatus 204 combines scores outputted by the versions into a value of response rate 212 by the candidate for the job. For example, analysis apparatus 204 may calculate response rate 212 as a linear combination of scores outputted by the global version, the personalized version for the candidate, and the job-specific version for the job.

A management apparatus 206 uses one or more values of response rate 212, a pacing score 240, and/or other factors associated with a member-job pair to generate an overall score 242 between the member and job. Management apparatus 206 also delivers a set of jobs to the member based on a ranking 244 of the jobs by overall score 242 with the member. For example, management apparatus 206 may dynamically calculate overall score 242 for a job using the following equations:

R_{m,j,t}=pctr_{m,j}*bid_{m,j,t}+μ*pApply_{m,j}

bid_{m,j,t}=*bid_{m,j}*f_{j,t}(Sa_{j,t}, Sp_{j,t})*f_{m,j}(h_{apply}, h_{quality})

In the above equations, R_{m,j,t} represents a ranking score R for a member m, job j, and time t; pctr_{m,j} represents a predicted CTR (i.e., a type of response rate 212) by the member for the job; bid_{m,j,t} represents a cost per action (CPA) 220 (e.g., a CPC) for the job, which is calculated as a dynamic bid price for the job with respect to the member and the time; μ represents a balancing factor that balances revenue with engagement in the ranking; and pApply_{m,j} represents the likelihood of the member applying to the job (i.e., another type of response rate 212). In turn, the dynamic bid price may be calculated from a value of an initial price for the job represented by bid_{m,j}, a first dynamic adjustment to the initial price represented by f_{j,t}, and a second dynamic adjustment to the initial price represented by f_{m,j}.

As described in the above-referenced application, f_{j,t} may include a value of pacing score 240 that is calculated from Sa_{j,t}, which represents an actual spending for the job at the time, and Sp_{j,t}, which represents the expected spending for the job at that time. In other words, pacing score 240 may be used to “boost” or “throttle” the delivery of the job (e.g., by increasing or decreasing the job's position 230 in ranking 244) based on the utilization of the job's budget at time t. Similarly, f_{m,j} may be calculated from h_{apply}, which represents a measure of application rates associated with the job, and h_{quality}, which represents a measure of applicant quality associated with the job. Thus, f_{m,j} may include a “performance” score that adjusts the ranking score to control for the quality of applicants and/or the application rate for the job.

Continuing with the above example, management apparatus 206 may generate a given ranking 244 of jobs by descending overall score 242 with respect to a given member and time and display ranking 244 to the member. After the member clicks on a job in ranking 244, the poster of the job may be charged the dynamic CPC (e.g., the value of bid_{m,j}) associated with the job in ranking 244, and the job's actual spending may be updated to reflect the charge. In turn, pacing score 240 and/or other components of overall score 242 for subsequent impressions of the job may be updated to reflect recent spending on the job triggered by the member's click.

In one or more embodiments, a model-creation apparatus 210 creates and/or updates machine learning models 208 based on responses 222 to jobs in ranking 244. For example, model-creation apparatus 210 may generate positive labels from positive responses 222 to the jobs, such as clicks on and/or applications for the jobs. Model-creation apparatus 210 may also generate negative labels from negative responses such as ignores or rejections of the jobs. Model-creation apparatus 210 may then use a training technique and/or one or more hyperparameters to update parameters 226 of machine learning models 208 so that predicted response rates 212 outputted by machine learning models 208 better reflect the corresponding labels. Model-creation apparatus 210 may then store updated parameters 226 and/or other data associated with machine learning models 208 in a model repository 234 and/or another data store for subsequent retrieval and use. Consequently, member responses 222 to jobs in ranking 244 may be collected by management apparatus 206 and fed back into various components of the system for use in adjusting subsequent pricing, scoring, and/or delivery of the jobs.

Those skilled in the art will appreciate that clicks, job applications, and/or other interactions that lead to charging of job posters may be infrequent, sporadic, and/or consume significant portions of the jobs' allocated budgets. For example, a job may be delivered in rankings to members hundreds or thousands of times before a member clicks on the job. At the same time, the infrequent nature of clicks on the job may result in static and/or dynamic CPCs that cause the job's daily budget to be depleted after a few to several clicks.

In one or more embodiments, analysis apparatus 204 calculates an impression-based spending 228 on jobs listed and/or delivered in the online system. Impression-based spending 228 includes estimates of spending on budgets (e.g., daily budgets) for the jobs based on impressions of the jobs within a certain time range (e.g., as the jobs' daily budgets are being spent). Such estimates are additionally generated independently of the payment model for the jobs. For example, analysis apparatus 204 may determine impression-based spending 228 for jobs that are charged using pay per click (PPC), pay per job application, and/or other types of payment models. Because impressions occur with much higher frequency than clicks, applications, and/or other actions resulting from the impressions, impression-based spending 228 may allow components of the system to assess spending and/or budget utilization of the jobs on a much more granular and/or regular basis than conventional techniques that evaluate and/or update spending based on sporadic and/or infrequent signals such as clicks, conversions, and/or applications.

In one or more embodiments, analysis apparatus 204 calculates impression-based spending 228 for a job (or other type of content) based on one or more response rates (e.g., response rate 212) by members to the job and CPA 220 for the corresponding type of response. For example, response rate 212 may include a predicted CTR for each impression of a job, and CPA 220 may include a PPC for the same job. In turn, impression-based spending 228 may be calculated using the following equation:

$$𝔼 [ spend ( j ) ] = {\sum }_{{imp}_{i {,}_{j}} ∈ {Imp}_{j}} pCTR ( {imp}_{i , j} ) \times CPC ( j ) \qquad ( 1 )$$

In the above equation, E[spend(j)] represents impression-based spending 228, which is calculated based on i impressions of job j (i.e., imp_{i,j}) out of all impressions of the job (i.e., Impⱼ). As shown in Equation 1, the predicted CTRs (i.e., pCTR) for the impressions are multiplied by the CPC for the job to produce expected costs of the impressions, and the expected costs are summed to produce a value of impression-based spending 228 for the i impressions.

The equation above may be adapted to compute impression-based spending 228 up to time t within a day:

$$ImpSpend ( j , t ) = {{\sum }_{{imp}_{i , j} s . t .}}_{timeStamp ( {imp}_{i , j} ) \leq t} pCTR ( {imp}_{i , j} ) \times CPC ( j ) \qquad ( 2 )$$

In the above equation, a value of impression-based spending 228 is calculated by multiplying the predicted CTRs for impressions of the job starting from the beginning of the day up to time t with the CPC for the job and summing the products. As a result, the value may be used as an estimate of the utilization of the job's daily budget up to time t in the day.

The equation above may additionally be adapted to a dynamic CPA 220 (e.g., bid_{m,j} described above) that is recalculated every time a ranking of jobs is generated for delivery to a member of the online system:

$$ImpSpend ( j , t ) = {{\sum }_{{imp}_{i , j} s . t .}}_{timeStamp ( {imp}_{i , j} ) \leq t} pCTR ( {imp}_{i , j} ) \times CPC ( j ) \qquad ( 3 )$$

In Equation 3 above, a fixed CPC for the job is replaced with a dynamic bid price for each impression of the job, which is paid when the member clicks on the job within the ranking. As mentioned above, the dynamic bid price may be calculated based on an initial price for the job, a first dynamic adjustment to the initial price that improves utilization of the job's budget, and/or a second dynamic adjustment to the initial price that improves the performance of the job.

Those skilled in the art will appreciate that jobs delivered to a member are subject to position bias, in which the member is more likely to take action on higher-ranked jobs than lower-ranked jobs in a given ranking 244. As a result, the accuracy of predicted CTRs, job application rates, and/or other values of response rate 212 generated by analysis apparatus 204 may be inversely proportional to the positions of the jobs within ranking 244. In turn, calculation and/or usage of impression-based spending 228 that is based on values of response rate 212 may be negatively impacted by the reduced accuracy of response rate 212 for jobs in some or all positions in ranking 244.

In one or more embodiments, analysis apparatus 204 improves the accuracy of impression-based spending 228 by calculating an updated response rate 214 for each job impression based on the original response rate 212 outputted by machine learning models 208, a given position 230 of the job in ranking 244, and/or additional dimensions 224 related to the impression of the job. In other words, analysis apparatus 204 calculates updated response rate 214 as a calibration of response rate 212 that accounts for position bias in a member's responses 222 to a job in ranking 244.

For example, analysis apparatus 204 may calculate updated response rate 214 using the following:

pResponse'=c(f, pResponse) (4)

In the above equation, pResponse represents updated response rate 214 for an instance of a member's impression of a job, f represents a set of dimensions 224 used to calibrate response rate 214, and pResponse' represents the resulting updated response rate 214 after the calibrations are applied. A function c is applied to dimensions 224 and response rate 212 to produce updated response rate 214.

Continuing with the above example, dimensions 224 may include a numeric position 230 of the job in a given ranking 244 that was viewed by the member. Dimensions 224 may also, or instead, include a model ID (e.g., name, version, etc.) and/or model type (e.g., predicted CTR model, predicted apply rate model, logistic regression model, neural network, etc.) of one or more machine learning models 208 used to produce response rate 212. Dimensions 224 may also, or instead, include an impression type associated with the impression (e.g., a “jobs homepage,” a job-related email, a job search results page, and/or another module, feature, or section of the online system in which the impression was made) and/or an impression channel associated with the impression (e.g., job recommendations, job search, job browsing, similar jobs, and/or other mechanisms used to deliver jobs to the member).

In turn, the function c for calculating updated response rate 214 may be estimated using the following likelihood optimization problem:

$${c}^{*} = {argmin}_{c ∈ C} {\prod }_{{imp}_{i} ∈ Imp} {c ( {f}_{i} , {pResponse}_{i} )}^{{y}_{i}} \cdot {( 1 - c ( {f}_{i} , {pResponse}_{i} ) )}^{1 - {y}_{i}} \qquad ( 5 )$$

In the above equation, yᵢ represents a response to impression impᵢ after the corresponding job is ranked and shown to the member. Using the above equation, the function c can be learned using various types of training data and/or have multiple forms.

In one or more embodiments, analysis apparatus 204 calculates updated response rate 214 using variations on one or more machine learning models 208 that were used to calculate response rate 212. For example, analysis apparatus 204 may input, into a machine learning model that calculates updated response rate 214 for a member's impression of a job, features that were inputted into a different machine learning model and/or a different version of the same machine learning model used to estimate the original response rate 212 for the same impression. Analysis apparatus 204 may additionally input encodings of the resulting position 230 of the job and/or additional dimensions 224 related to the impression into the machine learning model. In turn, the machine learning model may output a value of updated response rate 214 that accounts for position 230 and/or other dimensions 224 related to the context of the impression and/or predictions related to the impression (e.g., predictions of response rate 212). As with other machine learning models 208 used by analysis apparatus 204, model-creation apparatus 210 may update parameters of the machine learning model based on labels representing actual responses 222 to impressions, dimensions 224 representing the context of the impressions, and/or other features inputted into the machine learning model.

In one or more embodiments, analysis apparatus 204 also, or instead, calculates updated response rate 214 using a binning technique. During the binning technique, model-creation apparatus 210 and/or another component aggregate positive and negative responses 222 to impressions of jobs by dimensions 224 described above (e.g., position 230, model type, model ID, impression type, impression channel, etc.), as well as by a range of values (e.g., a minimum and maximum value) of response rate 212. Analysis apparatus 204 then calculates a value of updated response rate 214 for a given impression of a job from the distribution of responses 222 in a bin represented by the job's position 230 in ranking 244, the original response rate 212 for the impression, and/or dimensions 224 related to the impression.

For example, calculation of updated response rate 214 using the binning technique may be performed using the following:

pResponse'=p(response=1|position=pᵢ, impressionType=tᵢ, channelType=ctᵢ, pMinᵢ<pResponse<pMaxᵢ) (6)

The equation above includes a Bayes model that calculates the likelihood of a positive response to an impression i given a value of pᵢ for position 230, a value of tᵢ for impression type, a value of ctᵢ for channel type, and an uncalibrated response rate 212 bounded by pMinᵢ and pMaxᵢ.

The likelihood estimation problem represented by Equation 5 may then be optimized over Equation 6 using the following frequentist representation:

$$\begin{matrix}{pResponse}^{t} = \frac{Count ( response = 1 \vert ϒ )}{Count ( response = 0 \vert ϒ ) + Count ( response = 1 \vert ϒ )} \\ where & ( 7 ) \\ ϒ = \{ position = {p}_{i} , impressionType = {t}_{i} , channelType = {ct}_{i} , {pMin}_{i} < pResponse < {pMax}_{i} ) & ( 8 )\end{matrix}$$

After updated response rate 214 is calculated for a given impression of a job, analysis apparatus 204 combines updated response rate 214 with a corresponding CPA 220 to obtain a value of impression-based spending 228 that reflects the job's position 230 in ranking 244 from which the impression was made and/or additional dimensions 224 related to the impression. As discussed above, analysis apparatus 204 may additionally aggregate values of impression-based spending 228 for multiple impressions of a job (e.g., impressions of the job since the start of a time period over which the job's current budget is used) and/or other groupings of members and/or jobs to calculate an overall impression-based spending 228 for the grouping.

Management apparatus 206 uses values of impression-based spending 228 from analysis apparatus 204 to calculate values of pacing score 240. As discussed above, pacing score 240 may then be included in the calculation of overall score 242 for the corresponding jobs to influence placement of the jobs in ranking 244.

In one or more embodiments, management apparatus 206 calculates pacing score 240 for each job from a higher value selected from impression-based spending 228 and an actual spending on the job. For example, management apparatus 206 may calculate the spending on a job using the following:

spend(j, t)=max(ClickSpend(j, t), ImpSpend(j, t)) (9)

In the above equation, the spending on job j at time t is selected from the maximum of click-based spending (i.e., “ClickSpend”) calculated from clicks on the job and CPCs for the corresponding impressions and impression-based spending 228 (i.e., “ImpSpend”) estimated by analysis apparatus 204 from predicted CTRs representing updated response rate 214 and CPCs for the corresponding impressions. If impression-based spending 228 is higher, existing delivery of the job already produces impressions of the job, and clicks that spend the job's budget are expected to arrive. If impression-based spending 228 is lower, management apparatus 206 replaces the value of impression-based spending 228 with the actual click-based spending on the job to calculate pacing score 240.

In one or more embodiments, management apparatus 206 calculates pacing score 240 using an assumption that spending (e.g., the higher of impression-based spending 228 and actual spending) and/or the corresponding budget utilization for a job has a linear relationship with pacing score 240. Under this assumption, a change in pacing score 240 results in a corresponding linear change in spending on the job.

For example, spending on a job may be represented using the following:

sp_{j,t}=spend(j, t)−spend(j, t−1) (10)

In the above equation, sp_{j,t} represents a spending (e.g., the higher of click-based spending and impression-based spending 228) on job j at a time period represented by t, which is calculated by subtracting spending on the job up to t by spending on the job up to time t−1.

The linear relationship between spending on the job at the time and pacing score 240 may be represented using the following:

s(pr_{j, M})=w(M, j, t)*pr_{j,t}+b₀(M, j, t) (11)

In the above representation, pr_{j,t} represents pacing score 240 for the job at the time, w represents a linear weight for pacing score 240, and b₀ represents the spending capacity of the job when pacing score 240 is 0. Both w and b₀ depend on market conditions M, job j, and time period t.

Since market conditions can be assumed to stay the same for consecutive time periods t and t−1, and computation of pacing score 240 is performed separately for each job, j and M can be removed from the notation, and pacing score 240 can be calculated using the following equations:

$${d}_{t} = w \cdot {pr}_{t}^{*} + {b}_{0} \to {pr}_{t}^{*} = \frac{{d}_{t} - {b}_{0}}{w} , and , \\ {sp}_{t} - 1 = w \cdot {pr}_{t - 1} + {b}_{0} \to {pr}_{t - 1} = \frac{{sp}_{t - 1} - {b}_{0}}{w}$$

$${pr}_{t}^{*} = {pr}_{t - 1} \cdot \frac{{d}_{t} - {b}_{0}}{{sp}_{t - 1} - {b}_{0}}$$

In the equations above, prₜ* represents a value of pacing score 240 at time t, which is calculated from the previous value of pacing score 240, a desired spending at the time represented by dₜ, the spending at time t−1, and b₀. When a value of 0 for pacing score 240 prevents the job from being shown to members, b₀ has a value of 0. When a value of 0 for pacing score 240 does not prevent the job from being shown to members, a value of b₀ can be estimated from historical data (e.g., as the average spending on jobs that are similar to the job when pacing score 240 is set to 0).

By estimating spending based on impressions of content, the system of FIG. 2 is able to assess the utilization of budgets for the content on a more granular and/or frequent basis. In turn, the budget utilizations can be used to control the subsequent delivery of content in a way that prevents overspending or underspending related to the content.

In contrast, conventional techniques may determine spending and/or budget utilization for content based on more infrequent and/or erratic actions such as clicks and/or conversions, as well as prices charged per click and/or conversion, which can be a significant proportion of the budgets for the content. As a result, conventional spending and/or budget utilization estimates may fail to capture up-to-date exposure of users to the content, even when the exposure is sufficient and/or frequent enough to lead to actions that spend the budgets for the content. Instead, pacing and/or delivery of content based on the conventional spending and/or budget utilization estimates may result in overthrottling or underthrottling of the delivery of the content, which can cause suboptimal spending or lack of spending of the corresponding budgets. Consequently, the disclosed embodiments may provide improvements in computer systems, applications, user experiences, tools, and/or technologies related to delivering online content and/or carrying out activities within online systems.

Those skilled in the art will appreciate that the system of FIG. 2 may be implemented in a variety of ways. First, analysis apparatus 204, management apparatus 206, model-creation apparatus 210, and data repository 134 may be provided by a single physical machine, multiple computer systems, one or more virtual machines, a grid, one or more databases, one or more filesystems, and/or a cloud computing system. Analysis apparatus 204, management apparatus 206, and model-creation apparatus 210 may additionally be implemented together and/or separately by one or more hardware and/or software components and/or layers.

Second, a number of techniques may be used to estimate response rate 212, updated response rate 214, impression-based spending 228, pacing score 240, and/or overall score 242. For example, the functionality of analysis apparatus 204 and/or machine learning models 208 may be provided by one or more regression models, artificial neural networks, support vector machines, decision trees, naïve Bayes classifiers, Bayesian networks, random forests, gradient boosted trees, deep learning models, hierarchical models, and/or ensemble models. In another example, pacing score 240 may be calculated from impression-based spending 228 and/or another representation of spending for a job based on assumptions of logarithmic, exponential, and/or other types of relationships between amounts spent and pacing score 240. IN a third example, overall score 242 may be calculated from various combinations of prices, adjustments on the prices, predicted actions, and/or other factors.

Third, the functionality of the system may be adapted to various types of content and/or pricing. For example, the system may be used to predict actions, spending, and/or other metrics related to interaction with and/or delivery of advertisements, posts, images, audio, video, articles, forum posts, social media posts, online dating matches, and/or other types of online content.

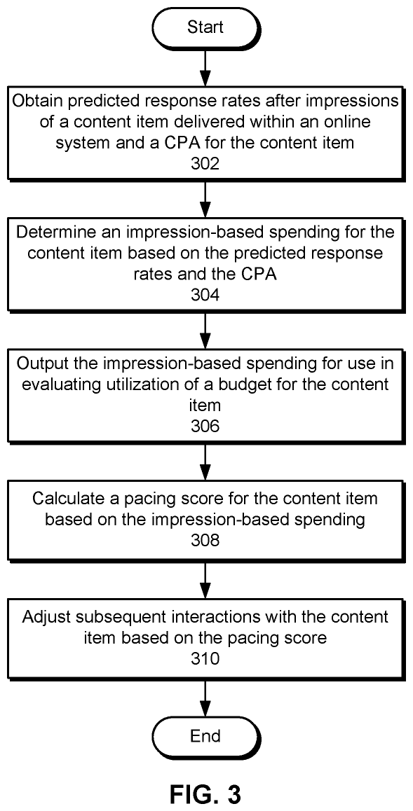

FIG. 3 shows a flowchart illustrating a process of performing impression-based pacing of delivery of a content item in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

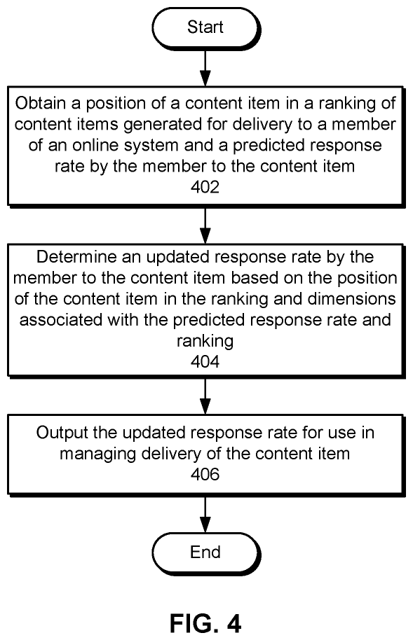

Initially, predicted response rates after impression of the content item delivered within an online system and a CPA for the content item are obtained (operation 302). For example, the predicted response rates may include predicted CTRs that account for the content item's position in rankings from which the impressions were made, as described in further detail below with respect to FIG. 4. In turn, the CPA may include CPCs associated with the predicted CTRs that are set based on the budget for the content item and/or calculated dynamically based on a number of factors.

Next, an impression-based spending for the content item is determined based on the predicted response rates and the CPA (operation 304). For example, each predicted response rate may be multiplied with a CPA for the corresponding impression to produce an expected cost of the impression, and the expected costs of a number of impressions of the content item (e.g., impressions occurring over a time period, impressions that were made during a period over which the budget is spent, etc.) may be summed to produce the impression-based spending.

The impression-based spending is then outputted for use in evaluating utilization of the budget for the content item (operation 306). For example, the impression-based spending may be stored in association with the content item and/or used to evaluate the utilization of the content item's budget (e.g., by comparing the proportional budget consumed by the impression-based spending with an expected budget consumption for the same time interval).

A pacing score for the content item is also calculated based on the impression-based spending (operation 308). For example, the pacing score may be calculated based on a previous value of the pacing score, a desired spending for the content item, and/or the impression-based spending. In another example, the pacing score may be calculated from a higher value of the impression-based spending and an actual spending for the content item during the same time interval.

Finally, subsequent interactions with the content item are adjusted based on the pacing score (operation 310). For example, the pacing score may be combined with other values into an overall score for the content item, and the content item's position in a ranking of content items is determined based on the overall score. The ranking may then be outputted to one or more members of the online system to deliver content in the ranking to the members. A lower pacing score may cause the content item's position in the ranking to drop, thereby reducing the likelihood that a member interacts with the content item after viewing the ranking. On the other hand, a higher pacing score may cause the content item's position in the ranking to increase, thus increasing the likelihood that a member interacts with the content item after viewing the ranking. In other words, the pacing score may be used to “throttle” or “boost” interactions with the content so consumption of the budget for the content can be distributed over the period in which the budget can be utilized (e.g., a day).

FIG. 4 shows a flowchart illustrating a process of performing post-ranking calibration of a response rate to a content item in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, the position of a content item in a ranking of content items generated for delivery to a member of an online system and a predicted response rate by the member to the content item are obtained (operation 402). For example, the content item's position in the ranking may be obtained after an overall score for the content item is calculated from a pacing score for the content item, the predicted response rate, and/or other factors, as described above. The predicted response rate may be obtained as output from a machine learning model after features associated with the content item and the member are inputted into the machine learning model.

Next, an updated response rate by the member to the content item is determined based on the position of the content item in the ranking and dimensions associated with the predicted response rate and ranking (operation 404). For example, the updated response rate may be determined based on dimensions that include the content item's position in the ranking, the type of impression of the content item, a channel over which the content item is delivered to the member, and/or a model used to produce the predicted response rate in operation 402. A binning technique may be used to calculate the updated response rate based on aggregated responses associated with a range of predicted rates of response that includes the predicted response rate by the member to the content item, the position of the content item in the ranking, and the dimensions. The updated response rate may also, or instead, be calculated by inputting the predicted response rate, the position of the content item in the ranking, and features related to the dimensions into a machine learning model and obtaining the updated response rate as output from the machine learning model.

Finally, the updated response rate is outputted for use in managing delivery of the content item (operation 406). For example, the updated response rate may be used to calculate an impression-based spending for the content item, as discussed above. In another example, the updated response rate may be used to perform response prediction and/or to estimate spending for other types of responses to the content item.

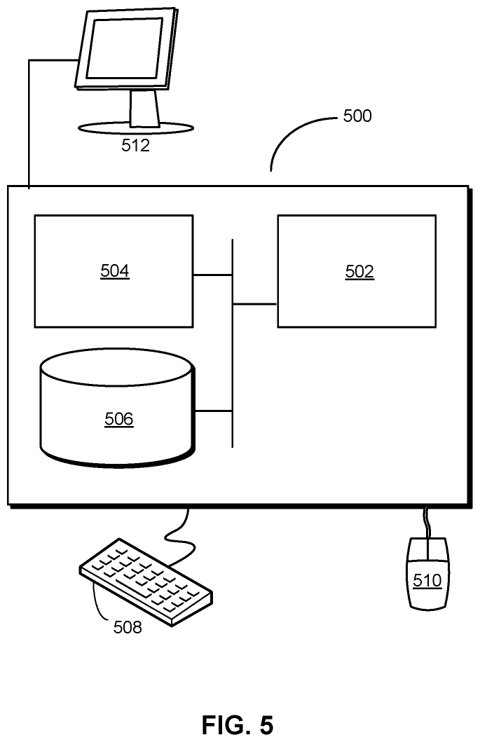

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for performing impression-based pacing for balanced delivery. The system includes an analysis apparatus and a management apparatus, one or more of which may alternatively be termed or implemented as a module, mechanism, or other type of system component. The analysis apparatus obtains predicted response rates associated with impressions of a content item delivered within an online system and a CPA for the content item. Next, the analysis apparatus determines an impression-based spending for the content item based on the predicted response rates and the CPA. The management apparatus then calculates a pacing score for the content item based on the impression-based spending. Finally, the management apparatus adjusts subsequent interactions with the content item based on the pacing score.

In one or more embodiments, the analysis apparatus also obtains a position of the content item in a ranking of content items generated for delivery to a member of an online system and a predicted response rate by the member to the content item. Next, the analysis apparatus determines an updated response rate by the member to the content item based on the position of the content item in the ranking and dimensions associated with the predicted response rate and the ranking. The analysis apparatus then outputs the updated response rate for use in managing delivery of the content item.

In addition, one or more components of computer system 500 may be remotely located and connected to the other components over a network. Portions of the present embodiments (e.g., analysis apparatus, management apparatus, model-creation apparatus, data repository, online network, etc.) may also be located on different nodes of a distributed system that implements the embodiments. For example, the present embodiments may be implemented using a cloud computing system that calculates impression-based spending and/or response rates related to impressions of jobs by a set of remote users and uses the impression-based spending and/or response rates to adjust delivery of the jobs to the remote users.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A non-transitory computer-readable storage medium storing instructions that when executed by a computer cause the computer to perform a method, the method comprising:
obtaining predicted response rates for a job and a cost per action (CPA) for the job;
determining an impression-based spending for the job based on the predicted response rates and the CPA; and
outputting the impression-based spending for use in evaluating utilization of a budget for the job.

2. The non-transitory computer-readable storage medium of claim 1, the method further comprising:
calculating a pacing score for the job based on the impression-based spending; and
adjusting subsequent delivery of the job based on the pacing score.

3. A method, comprising:
obtaining predicted response rates associated with impressions of a content item delivered within an online system and a cost per action (CPA) for the content item;
determining, by one or more computer systems, an impression-based spending for the content item based on the predicted response rates and the CPA; and
outputting the impression-based spending for use in evaluating utilization of a budget for the content item.

4. The method of claim 3, further comprising:
calculating a pacing score for the content item based on the impression-based spending; and
adjusting subsequent interactions with the content item based on the pacing score.

5. The method of claim 4, wherein calculating the pacing score for the content item based on the impression-based spending comprises:
calculating the pacing score based on a previous value of the pacing score, a desired spending for the content item, and the impression-based spending.

6. The method of claim 4, wherein calculating the pacing score for the content item based on the impression-based spending comprises:
calculating the pacing score from a higher value of the impression-based spending and an actual spending for the content item.

7. The method of claim 4, wherein adjusting subsequent interactions with the content item based on the pacing score comprises:
determining, based on the pacing score, a position of the content item in a ranking of content items; and
outputting the ranking to one or more members of the online system.

8. The method of claim 3, wherein obtaining the predicted response rates comprises:
inputting features associated with the content item and members of the online system into a machine learning model; and
obtaining the predicted response rates of the members, given the impressions of the content item by the members, as output from the machine learning model.

9. The method of claim 8, wherein obtaining the predicted response rates further comprises:
updating the predicted response rates based on the positions of the content item in rankings outputted to the members.

10. The method of claim 3, wherein obtaining the CPA comprises:
obtaining an updated price for the content item based on an initial price of the content item and one or more dynamic adjustments to the initial price.

11. The method of claim 3, wherein determining the impression-based spending for the content item based on the predicted response rates and the CPA comprises:
multiplying the predicted response rates with corresponding values for the CPA to produce expected costs of the impressions; and
summing the expected costs of the impressions into the impression-based spending for the content item.

12. The method of claim 11, wherein determining the impression-based spending for the content item based on the predicted response rates and the CPA further comprises:
selecting the predicted response rates and the CPA to span a time period over which a budget for the content item has been utilized.

13. The method of claim 3, wherein the content item comprises a job.

14. The method of claim 13, wherein the predicted response rates comprise at least one of:
a likelihood of a click on the job; and
a likelihood of an application for the job.

15. The method of claim 13, wherein the CPA comprises at least one of:
a cost per click (CPC); and
a cost per job application.

16. A system, comprising:
one or more processors; and
memory storing instructions that, when executed by the one or more processors, cause the system to:
obtain predicted response rates associated with impressions of a content item delivered within an online system and a cost per action (CPA) for the content item;
determine an impression-based spending for the content item based on the predicted response rates and the CPA;
calculate a pacing score for the content item based on the impression-based spending; and
adjust subsequent interactions with the content item based on the pacing score.

17. The system of claim 16, wherein calculating the pacing score for the content item based on the impression-based spending comprises at least one of:
calculating the pacing score based on a previous value of the pacing score, a desired spending for the content item, and the impression-based spending; and
calculating the pacing score from a higher value of the impression-based spending and an actual spending for the content item.

18. The system of claim 16, wherein determining the impression-based spending for the content item based on the predicted response rates and the CPA comprises:
multiplying the predicted response rates with corresponding values for the CPA to produce expected costs of the impressions; and
summing the expected costs of the impressions into the impression-based spending for the content item.

19. The system of claim 18, wherein determining the impression-based spending for the content item based on the predicted response rates and the CPA further comprises:
selecting the predicted response rates and the CPA to span a time period over which a budget for the content item has been utilized.

20. The system of claim 16, wherein:
the content item comprises a job;
the predicted response rates comprise a predicted click-through rate (CTR) for the job; and
the CPA comprises a cost per click (CPC) for the job.
